(19) United States
(12) Patent Application Publication
(10) Pub. No.: US 2014/0089855 A1
(43) Pub. Date: Mar. 27, 2014

(54) METHOD AND DEVICE FOR EXECUTING A SPECIFIC OPERATION BASED ON WRITING

(71) Applicant: Pantech Co., Ltd., Seoul (KR)

(72) Inventors: Jong-Gon KIM, Seoul (KR); Jin-Young Roh, Seoul (KR); Mi-Sun Hwang, Seoul (KR)

(73) Assignee: Pantech Co., Ltd., Seoul (KR)

(21) Appl. No.: 14/035,261

(22) Filed: Sep. 24, 2013

(30) Foreign Application Priority Data
Sep. 24, 2012 (KR) 10-2012-0106051

(51) Int. Cl. G06F 3/0482; G06F 3/0481

(52) U.S. Cl. CPC G06F 3/0482; G06F 3/04817
USPC 715/835

(57) ABSTRACT

A method and device for executing a specific operation based on a writing input are described. A method utilizing a processor, the method including: recognizing writing input to obtain writing data; extracting feature information from the writing data; searching for applications that operate with the writing data based on the feature information to form an application candidate group; and displaying icons corresponding to applications included in the application candidate group.

### CROSS-REFERENCE TO RELATED APPLICATION

This application claims the benefit of and priority under 35 U.S.C. §119(a) of Korean Patent Application No. 10-2012-0106051, filed on Sep. 24, 2012, the entire disclosure of which is incorporated herein by reference for all purposes.

### BACKGROUND

1. Field

The following description relates to a method and device for executing a specific operation based on writing, and more particularly, to a method and portable terminal for executing a specific operation of interworking writing input contents based on the writing contents input by a user.

2. Description of the Background

High-performance terminals, for example, smartphones, include a high-performance processor like a personal computer and a large capacity memory, which allow a user to install and use an application program therein, have recently been universally used.

A smartphone is a terminal combining a mobile phone operation with a data communication operation, such as, schedule management or Internet access. The smartphone has advantages in that a user may directly access the Internet in a wireless manner, may install and use desired various applications, and may easily share a variety of data between smartphones having the same operation system (OS), unlike an existing mobile phone, and thus the share of such a smartphone is rapidly increasing in the mobile phone market. With the advent of smartphones, the demand for an application that may be installed and executed in a smartphone has increased and various applications have been developed and provided.

Conventionally, when a user is to execute a specific application from among various applications installed in a smartphone, a process of learning the application in advance, directly searching for the application to be executed, and selecting the application is required. In addition, when the user is to use the application, a process of inputting contents in accordance with a type of the application, ending the application when there is no desired operation in the application, searching for another application that may perform the desired operation, and selecting the other application is required. That is, a process of selecting, executing, and inputting contents in accordance with a type of the application is repeated.

Accordingly, when a user uses a smartphone in which various applications are installed and executed, the user has to learn the application in advance and has to inconveniently search for the application several times.

A smartphone that supports a writing input using a finger or a stylus pen has a disadvantage in that writing may be input only when an exclusive application that supports a writing input is first executed. Accordingly, there is a demand for a method that may easily input writing and easily access a specific application.

### SUMMARY

Exemplary embodiments of the present invention provide a method and device for executing a specific operation based on writing.

Additional features of the invention will be set forth in the description that follows, and in part will be apparent from the description, or may be learned by practice of the invention.

Exemplary embodiments of the present invention disclose a method utilizing a processor, the method including: recognizing writing input to obtain writing data; extracting feature information from the writing data; searching for applications that operate with the writing data based on the feature information to form an application candidate group; and displaying icons corresponding to applications included in the application candidate group.

Exemplary embodiment of the present invention disclose a device including: a writing recognizing unit configured to recognize writing input to obtain writing data; an information extracting unit configured to extract feature information from the writing data; an application search unit configured to search for applications that operate with the writing data based on the feature information to form an application candidate group; and an application providing unit configured to display icons corresponding to applications included in the application candidate group.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a representative configuration of a device for executing a specific operation based on writing, according to exemplary embodiments of the present invention.

FIG. 2 is a block diagram illustrating a configuration of a writing interface unit according to exemplary embodiments.

FIG. 3 is a diagram illustrating an example of the writing interface unit according to exemplary embodiments.

FIG. 4 is a block diagram illustrating a configuration of a control unit according to exemplary embodiments.

FIG. 5 is a view illustrating an example of executing a specific operation based on writing, according to exemplary embodiments of the present invention.

FIG. 6A and FIG. 6B are views illustrating a process of editing a text, according to exemplary embodiments of the present invention.

FIG. 7, FIG. 8, FIG. 9 and FIG. 10 are views illustrating an example of executing a specific operation based on writing, according to exemplary embodiments of the present invention.

FIG. 11A and FIG. 11B are flowcharts illustrating a method of executing a specific operation based on writing, according to exemplary embodiments of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

In addition, embodiments described in the specification are wholly hardware, and may be partially software or wholly software. In the specification, “unit”, “module”, “device”, “system”, or the like represents a computer related entity such as hardware, combination of hardware and software, or software. For example, in the specification, the unit, the module, the device, the system, or the like may be an executed process, a processor, an object, an executable file, a thread of execution, a program, and/or a computer, but are not limited thereto. For example, both of an application which is being executed in the computer and a computer may correspond to the unit, the module, the device, the system, or the like in the specification.

The term ‘application’ used herein refers to an application for performing each operation provided by a device and an application downloaded from the outside. Examples of an application include a camera application, a calculator application, a web browser search application, a phone application, a game application, a memo or note application, an application for transmitting/receiving a message using a short message service (SMS) or a multimedia messaging service (MMS), a schedule application including a schedule management operation, and an application that provides an instant messenger service.

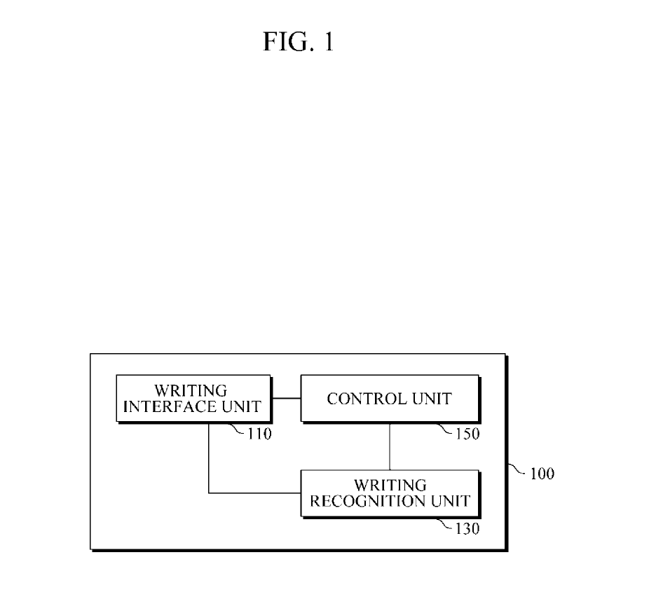

FIG. 1 is a block diagram illustrating a representative configuration of a device for executing a specific operation based on writing, according to exemplary embodiments of the present invention. A device 100 according to exemplary embodiments of the present invention includes a writing interface unit 110, a writing recognition unit 130, and a control unit 150. The device 100 includes a touch screen or a touch panel to receive a writing input from a user, and the writing interface unit 110 is provided on the touch screen or the touch panel. For example, the device 100 may include a smartphone, a laptop, a desktop PC, or the like, that supports a writing input using a touch screen, a stylus pen, or the like. According to exemplary embodiments, device 100 can include accepting a writing input using a body part, such as, a fingertip. However, aspects need not be limited thereto such that a touch screen may be omitted and the writing may be input according to the movement of a pointer associated with a mouse or touch pad with or without one or more clicks of a mouse or touch pad button.

Since the writing interface unit 110 is provided on the touch screen or the touch panel, the writing interface unit 110 operates to receive a touch or a writing input (using a finger or an electronic pen) from the user, and to display writing contents input by the user.

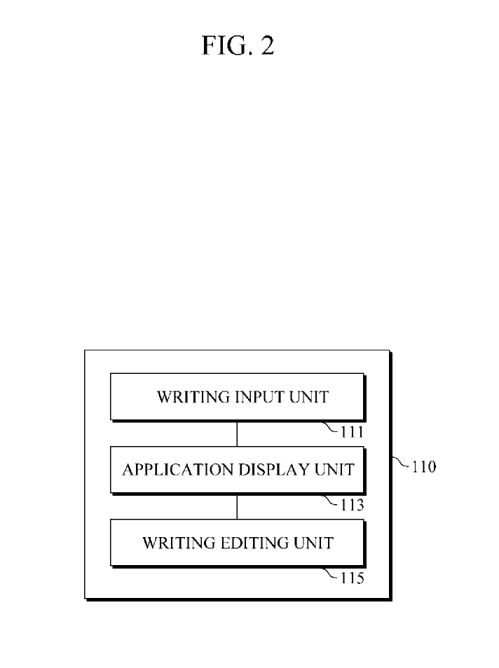

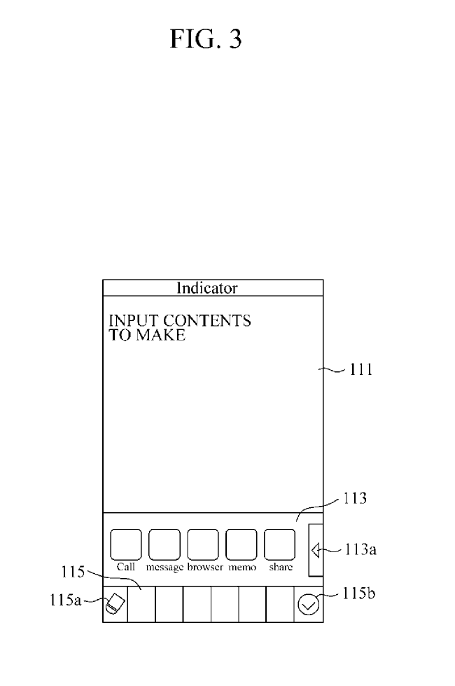

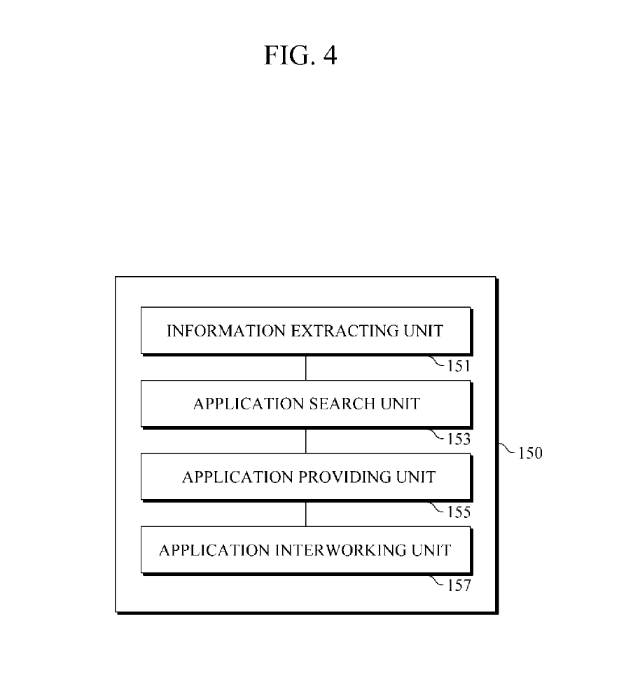

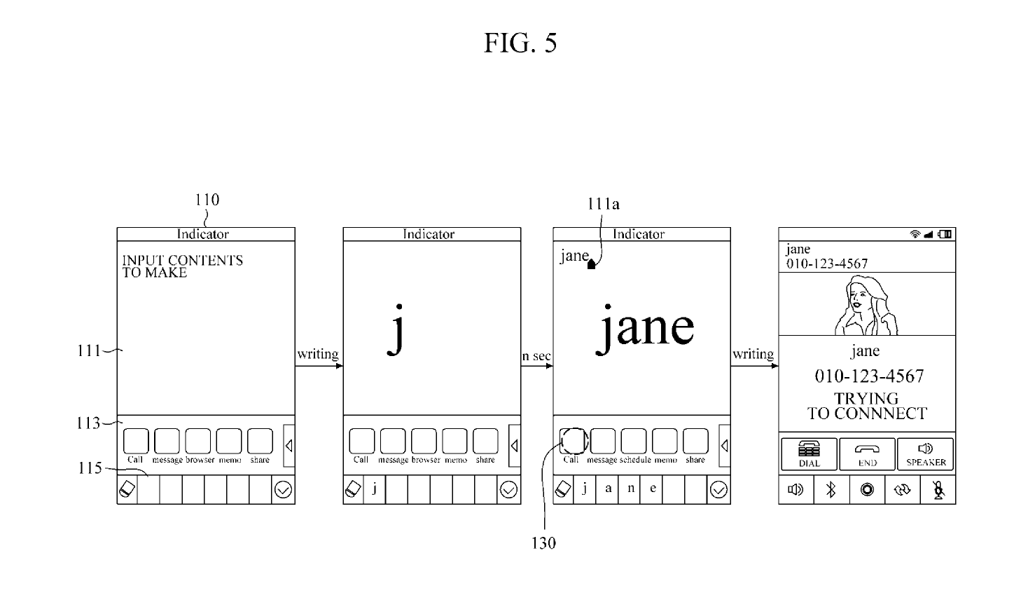

The writing interface unit 110 will be explained in more detail with reference to FIGS. 2 and 3. FIG. 2 is a block diagram illustrating a configuration of a writing interface unit according to exemplary embodiments. FIG. 3 is a diagram illustrating an example of the writing interface unit according to exemplary embodiments. Referring to FIG. 2 and FIG. 3, the writing is interface unit 110 includes a writing input unit 111, an application display unit 113, and a writing editing unit 115.

The writing input unit 111 displays both the writing contents input by the user and a text obtained by converting the writing contents input by the user through the writing recognition unit 130.

A writing input area where the writing input is received and a text display area where the text is displayed may be different from each other, or all areas of the writing input unit 111 may be writing input areas where the writing input is received irrespective of a text display area where the text is displayed. Assuming that the writing input area and the text display area are the same, when the user inputs writing, the writing is converted by the writing recognition unit 130 into text. The text may be displayed in a preset font disposed on a side of the writing input unit 111. The writing input and the displayed text may be distinguished from each other with a visual effect, for example, different colors.

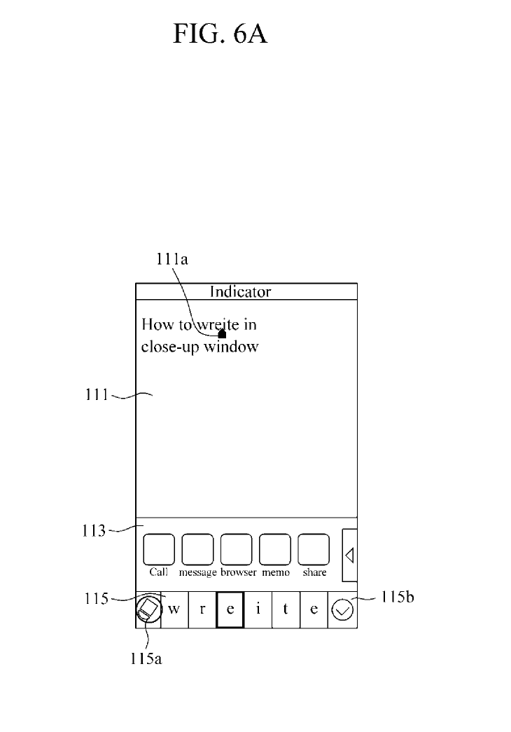

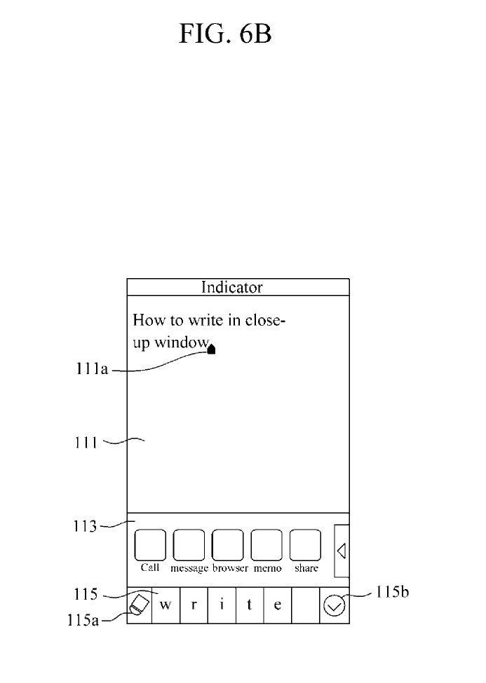

A pointer or cursor 111a (see FIG. 6A or FIG. 6B) indicating a position to which the text is input by the user is displayed, for example, at an end of the text displayed on the writing input unit 111 (see FIG. 5). The pointer 111a may indicate an editing position when the user edits the text using the writing editing unit 115. The writing input unit 111 cooperates with the writing editing unit 115 to reflect and display edited contents obtained by the writing editing unit 115.

The application display unit 113 may display one or more screens of an application that include provisions to accept the writing contents input by the user so that the user may operate the application. The application display unit 113 may display an application candidate group provided by the control unit 150 as an icon, and thus the user may interwork or is provide the writing contents to one of the displayed applications. The interworking can include connecting, communicating, or exchanging the writing contents to an application selected from the application candidate group. In FIG. 5, the application display unit 113 is populated with an exemplary application candidate group, including a phone (labeled as call in FIG. 5), messaging (labeled as message), a calendar (labeled as schedule), a memo, and a sharing (labeled as share) application.

The application display unit 113 may include a direction button 113a that may enable the user to see a non-displayed application when the application candidate group provided by the control unit 150 is not all displayed in a displayable area.

When the text input to the writing input unit 111 is a preset symbol or a specific text, the application display unit 113 displays an operation icon corresponding to the preset symbol or the specific text, where the operation icon changes as the preset symbol changes. For example, when a symbol ‘?’ is input, the application display unit 113 may display a search icon for executing an application for providing a search operation, and when a formula including an arithmetic operation or mathematical symbol is input, the application display unit 113 may display an icon ‘=’ for executing an application for providing a calculation operation.

The writing editing unit 115 may correct an error when there is an error in the writing contents input by the user. The writing editing unit 115 may be divided into a plurality of cells for easier correction. The text displayed on a side of the writing input unit 111 may be sequentially displayed in the cells of the writing editing unit 115, for example, by displaying a letter in a cell, a partial word in a cell, a whole word in a cell, or the like.

Referring to FIG. 3, an editing button 115a for executing a text editing operation is provided on a side of the writing editing unit 115, and a confirmation button 115b having an is operation of confirming edited contents is provided on the other side of the writing editing unit 115. Although the editing button 115a is displayed as an eraser-like icon and the confirmation button 115b is displayed as a ‘v’-like icon in FIG. 3, the present embodiment is not limited thereto.

When the user wants to edit a text displayed on the writing input unit 111, the user may delete the text by selecting the editing button 115a and selecting a cell to be corrected from among the cells of the writing editing unit 115. The user may delete the text by first selecting a letter displayed in a cell and then selecting the editing button 115a. In some embodiments, once the user selects a letter to be corrected displayed on the writing input unit 111, the letter displayed in a corresponding cell of the writing editing unit 115 may be selected and the user may edit the text.

After selecting and deleting the text, the user may insert additional text. The user may insert the additional text by inputting writing data to the writing input unit 111. To confirm the edited content, the confirmation button 115b may be selected and the edited contents may be reflected on the writing input unit 111.

FIG. 6A and FIG. 6B are views illustrating a process of editing a text, according to exemplary embodiments of the present invention.

For example, referring to FIG. 6A, when the user inputs “How to wreite in close-up window” to the writing input unit 111, input contents is displayed on a side of the writing input unit 111. When the user selects a portion to be corrected, for example, “wreite,” the letters that include the term “wreite” may be displayed in respective cells of the writing editing unit 115, and the user may select the editing button 115a and select a letter of a desired cell, and edit the letter by deleting it. Next, referring to FIG. 6B, when the user selects the confirmation button 115b to complete the correction, the pointer 111a is moved to an end of the text displayed on the writing input unit 111 and the editing ends.

Also, although not shown, when the editing button 115a of the writing editing unit 115 is touched for a predetermined period of time or longer or a preset specific area is touched for a predetermined period of time or longer, the overall text displayed on the writing editing unit 115 may be deleted. When more text needs to be inserted into the text displayed on the writing input unit 111, the text may be inserted by generating the pointer 111a on an area where the other text needs to be inserted and inputting writing to the writing input unit 111.

Although the writing interface unit 110 controls overall operations for inputting and displaying writing, the control unit 150 may control all contents input to and displayed on the writing interface unit 110 based on writing data recognized by the writing recognition unit 130, and the writing interface unit 110 may just display the input contents.

Next, the writing recognition unit 130 may recognize the writing input received from the writing interface unit 110, where the recognizing may extract the writing data, convert the writing data into a text, and store the text. The writing recognition unit 130 recognizes the writing data and converts the writing data into the text using a writing recognition algorithm, and the text is transmitted to the control unit 150 and the writing interface unit 110.

The control unit 150 receives feature information from the writing data extracted by the writing recognition unit 130, and searches for and displays an application candidate group in which the writing data may be interworked using the extracted feature information. To this end, the control unit 150 may include an information extracting unit 151, an application search unit 153, an application providing unit 155, and an application interworking unit 157. In some embodiments, the control unit 150 may provide all of the elements without the elements being is separated.

The information extracting unit 151 operates to extract feature information from writing data. The term “feature information” includes information about characteristics of writing data including information indicating whether the writing data is data about a name, a phone number, an address, an E-mail address, a timestamp, a data about a formula including an arithmetic operation symbol, a preset symbol or specific text data.

The application search unit 153 searches for an application capable of interworking with the writing data using the feature information extracted by the information extracting unit 151. For example, assuming that the feature information is information indicating that the writing data is text data, the application search unit 153 may search for text-based applications, such as, a memo application, a schedule application, or a message application, that use the text data as an application and are capable of interworking the writing data.

The application providing unit 155 cooperates with the writing interface unit 110 to provide a searched application candidate group to the writing interface unit 110.

When a user selects a specific application using the writing interface unit 110, the application interworking unit 157 interworks and executes the writing data with the specific application selected by the user.

FIG. 5 is a view illustrating an example of executing a specific operation based on writing, according to exemplary embodiments of the present invention. For example, it is assumed that writing data extracted by the writing recognition unit 130 is “jane” and the writing data “jane” is stored in a phone directory. The control unit 150 extracts feature information from the writing data “jane,” and the extracted feature information is information indicating that the writing data “jane” is name data and text data. As the control unit 150 searches the phone is directory and the writing data “jane” is found, the control unit 150 includes applications that interwork with the phone directory, for example, a phone application, a message application, a share application, and the like in an interworkable application candidate group. As the writing data “jane” is text data, the control unit 150 includes a memo application and a schedule application, which uses text data in the interworkable application candidate group. That is, for the writing data “jane,” a phone application, a message application, a share application, a memo application, and a schedule application are selected and included in the interworkable application candidate group. The interworkable application candidate group is illustrated in the application display unit 113 of FIG. 5. A user can select an application, for example, with a tap 130, the application display unit 113 is populated with an application candidate list, including at least a phone (labeled as call in FIG. 5), messaging (labeled as message), a calendar (labeled as schedule), a memo, and a sharing (labeled as share). A user can select an application from the application candidate group by a tap 130.

However, when the writing data “jane” is not stored in the phone directory, that is, when the writing data “jane” is not found in the phone directory, a web browser search application may be added to the interworkable application candidate group. In some embodiments, irrespective of whether the writing data “jane” is found in the phone directory, the web browser search application may be added to the interworkable application candidate group. Just in case in which the feature information extracted from the writing data is not found in a device resource, such as, the phone directory, a search application may be provided as default to the application display unit 113.

When writing data corresponds to a preset symbol or a specific text, the control unit 150 may provide an application icon or an operation icon corresponding to the symbol or the is text to the application display unit 113.

For example, when the writing data includes number data and a specific delimiter (for example, “-”) data and has a phone number format, the control unit 150 may display a phone application. In exemplary embodiments, when the writing data includes question mark delimiter data, the control unit 150 may display a search application; when the writing data includes number data and arithmetic operation symbol data and has a numerical formula format, the control unit 150 may display a calculator application; and when the writing data includes ‘hour’ and ‘minute’ text data and has a 24-hour time format, the control unit 150 may search for and display a schedule application.

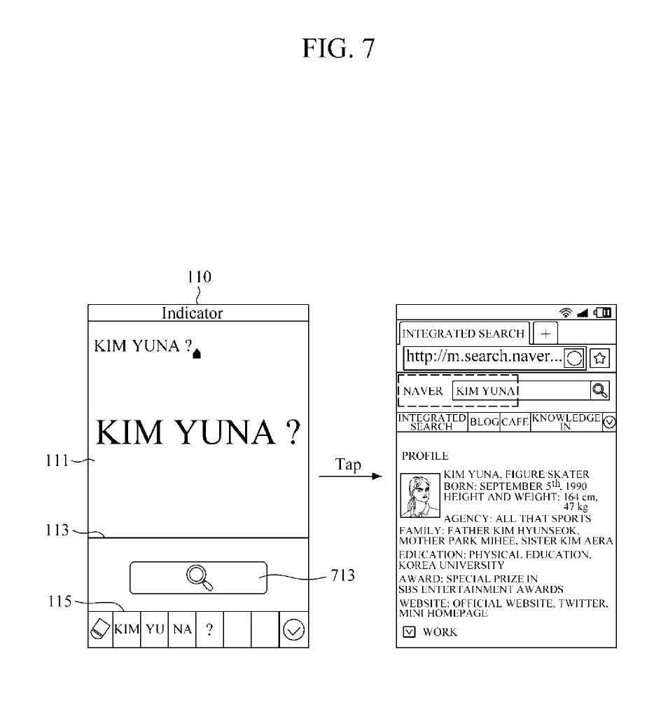

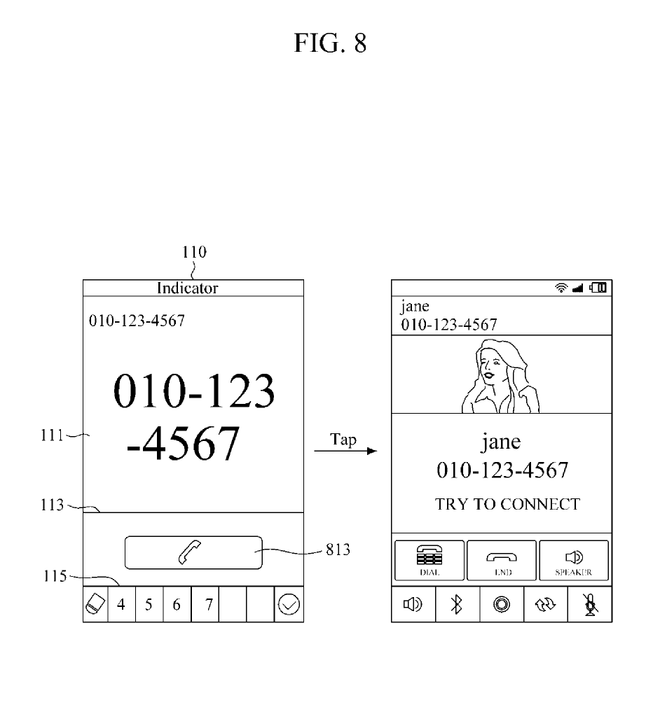

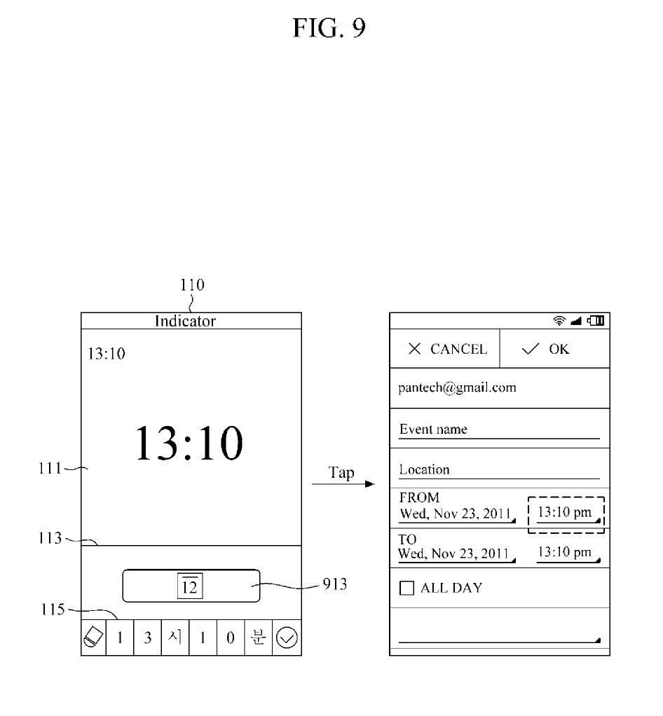

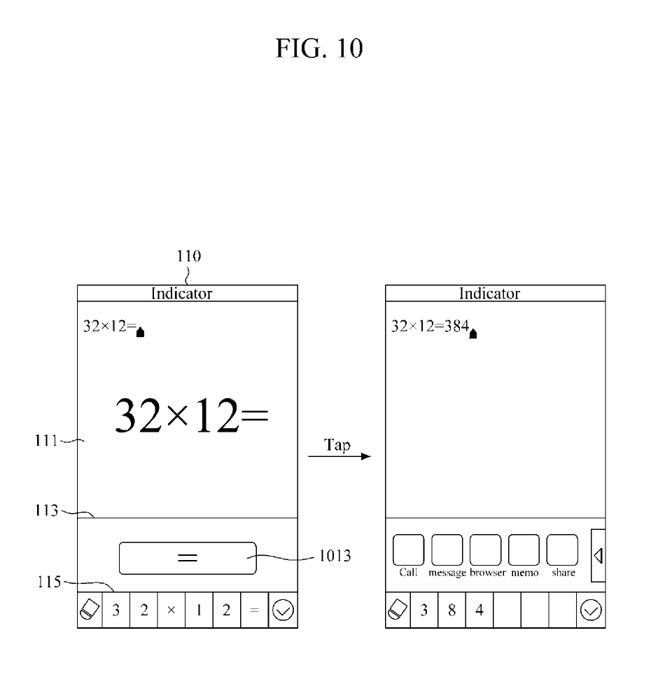

FIG. 7, FIG. 8, FIG. 9 and FIG. 10 are views illustrating an example of executing a specific operation based on writing, according to exemplary embodiments of the present invention.

Referring to FIG. 7, when the user inputs “Kim Yuna?” to the writing input unit 111, the writing recognition unit 130 recognizes a writing input, extracts writing data “Kim Yuna?”, and converts the writing data “Kim Yuna?” into text data. The text data converted by the writing recognition unit 130 is displayed, here, for example, on an upper end of the writing input unit 111, both writing contents as written or input by the user and the converted text are displayed on the writing input unit 111. As a question mark “?” is included in the writing data “Kim Yuna?” extracted by the writing recognition unit 130, the control unit 150 determines that the user intends to search, and searches for a web browser application including a search operation and provides the web browser application to the application display unit 113. Next, when the user selects a web browser search application execution icon 713 to execute the web browser search application, the web browser search application interworks the writing data “Kim Yuna” excluding the question mark and a result of the search is displayed. According to exemplary embodiments, a predetermined specific candidate group can be provided for a symbol. For example, a “?” could populate the application candidate group with various web-search applications, a “-” could populate the application candidate group with phone number applications, such as, contact or phone, a “:” could populate the application candidate group with calendar, alarm or appointment applications.

Referring to FIG. 8, when the user inputs “010-123-4567” to the writing input unit 111, the writing recognition unit 130 recognizes a writing input, extracts writing data “010-123-4567”, and converts the writing data “010-123-4567” into text. Since the text converted by the writing recognition unit 130 is displayed on an upper end of the writing input unit 111, both the writing contents input by the user and the converted text are displayed on the writing input unit 111. As the feature information extracted from the writing data “010-123-4567” includes number data and specific delimiter (-) data and has a phone number format, the control unit 150 may determine that the user intends to execute an operation using a phone number, and may display a related application on the application display unit 113. In FIG. 8, a phone application execution icon 813 is displayed on the application display unit 113. When the user selects the phone application execution icon 813 to execute a phone application, the phone application interworks with the writing data “010-123-4567.”

Referring to FIG. 9, when the user inputs “13:10” to the writing input unit 111, the writing recognition unit 130 recognizes a writing input, extracts writing data “13:10”, and converts the writing data “13:10” into a text. Since the text converted by the writing recognition unit 130 is displayed on an upper end of the writing input unit 111, both writing contents input by the user and the converted text are displayed on the writing input unit 111. Since feature is information extracted from the writing data “13:10” includes ‘hour’ and ‘minute’ text data and has a 24-hour time format’, the control unit 150 searches for a schedule application and displays the schedule application on the application display unit 113. Next, when the user selects a schedule application execution icon 913 to execute a schedule application, the schedule application interworks with the writing data “13:10.”

Referring to FIG. 10, when the user inputs “32×12=” to the writing input unit 111, the writing recognition unit 130 recognizes a writing input, extracts writing data “32×12=”, and converts the writing data “32×12=” into a text. As the text converted by the writing recognition unit 130 is displayed on an upper end of the writing input unit 111, both writing contents input by the user and the text are displayed on the writing input unit 111. As feature information extracted from the writing data “32×12=” includes number data and arithmetic operation symbol data and has a numerical formula format, the control unit 150 automatically searches for a calculator application and provides the calculator application to the application display unit 113, for example, when an “=” sign is extracted. Next, when the user selects a calculator application execution icon 1013 to execute a calculator application, the calculator application interworks the writing data “32×12=” and a calculation result is displayed.

As described above, when a preset symbol or format is input, the control unit 150 may search for a preset application and provide the preset application to the application display unit 113. Settings of an application to be provided according to a preset symbol or format may be changed by the user.

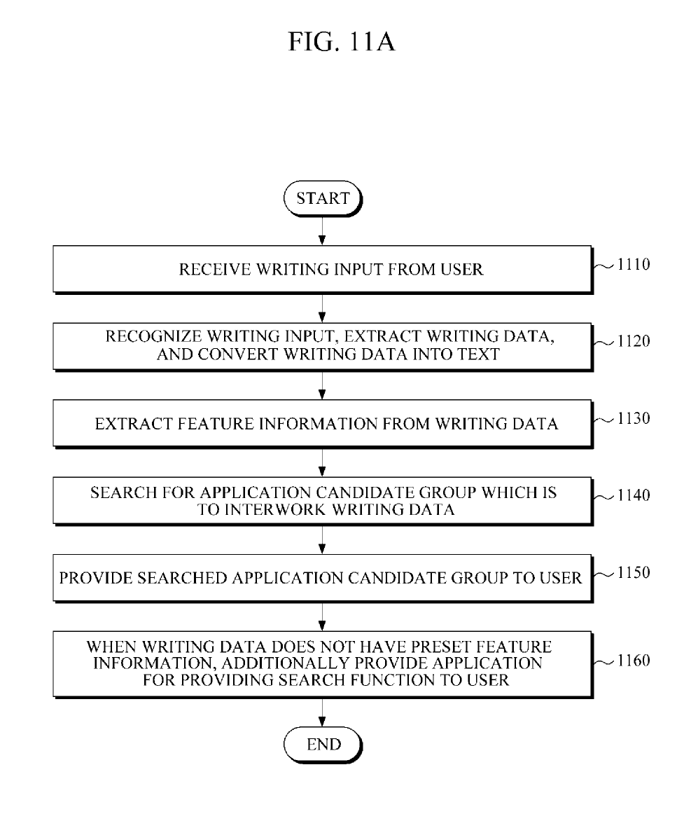

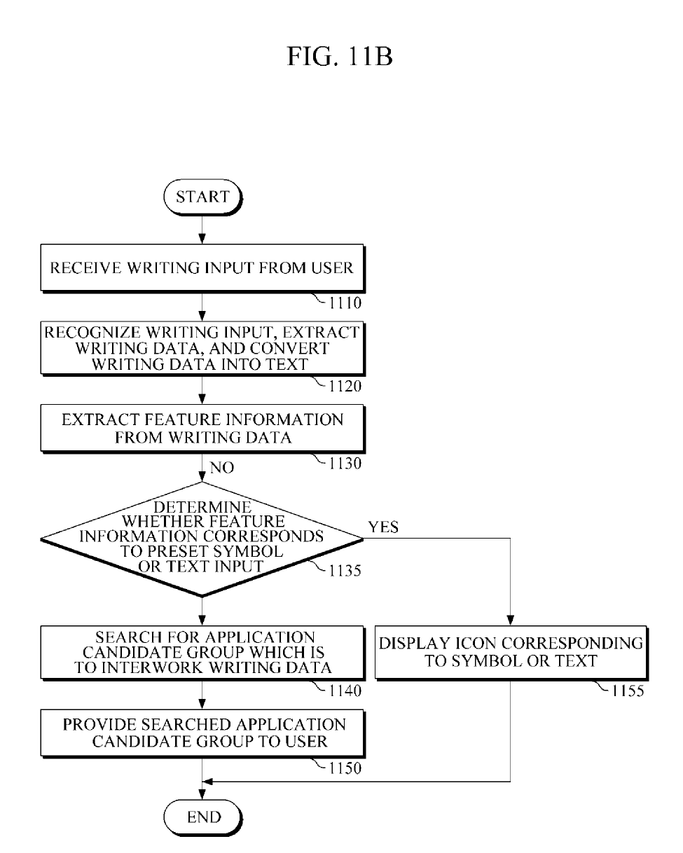

FIG. 11A and FIG. 11B are flowcharts illustrating a method of executing a specific operation based on writing, according to exemplary embodiments of the present invention (and the same elements are denoted by the same reference numerals and a detailed is explanation thereof will not be given).

Referring to FIG. 11A, in operation 1110, a writing input is received from a user through the writing input unit 111 included in the writing interface unit 110. In operation 1120, the writing recognition unit 130 recognizes the writing input, extracts writing data, and converts the writing data into a text. The text is displayed on a side of the writing input unit 111 along with writing contents of the user. In operation 1140, the control unit 150 searches for an application candidate group which is to interwork the writing data. In operation 1150, the searched application candidate group is provided to the user through the application display unit 113. The application candidate group provided by the control unit 150 is displayed as an icon on the application display unit 113.

In some embodiments, the method may include operation 1130 in which feature information is extracted from the writing data before operation 1140. That is, the feature information of the writing data may be extracted based on the writing data extracted by the writing recognition unit 130, and the application candidate group to interwork the writing data may be searched according to the extracted feature information.

The feature information may be, for example, a name, a phone number, an address, an E-mail address, a time, or a formula including an arithmetic operation symbol.

When the writing data does not include the feature information, the method may to include operation 1160 in which an application for providing a search operation is provided to the user through the application display unit 113.

Referring to FIG. 11B, before operation 1140 in which the application candidate group is searched, the method may further include operation 1135 (illustrated in FIG. 11B) in which it is determined whether the extracted feature information corresponds to a preset symbol is or text input. When the extracted feature information corresponds to a preset symbol or text input, the method proceeds to operation 1155. In operation 1155, an operation icon corresponding to the preset symbol or text input may be displayed and available for execution on the application display unit 113.

The above description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

According to aspects of the present invention, since the number of operations of selecting and executing a specific application may be reduced and an appropriate application may be automatically provided based on writing contents input by a user, user convenience may be improved greatly.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method utilizing a processor, the method comprising:
recognizing a writing input to obtain writing data;
extracting feature information from the writing data;
searching for applications that operate with the writing data based on the feature information to form an application candidate group; and
displaying icons corresponding to applications included in the application candidate group.

2. The method of claim 1, further comprising:
receiving a selection of an application included in the application candidate group; and
executing the selected application to interwork with text included in the writing data.

3. The method of claim 2, further comprising displaying a result based on the writing data of the executing of the selected application.

4. The method of claim 1, wherein the application candidate group includes zero applications, and the method further comprises providing a search application as a member of the application candidate group.

5. The method of claim 1, wherein the feature information comprises a mathematical symbol and at least one application of the application candidate group comprises a calculator.

6. The method of claim 1, wherein the feature information comprises a dash and at least one application of the application candidate group comprises a phone.

7. The method of claim 1, wherein the feature information comprises a question mark and at least one application of the application candidate group comprises a search application.

8. The method of claim 1, further comprising changing the application candidate group as the feature information changes.

9. The method of claim 1, further comprising editing the written input.

10. A device comprising:
a writing recognizing unit configured to recognize writing input to obtain writing data;
an information extracting unit configured to extract feature information from the writing data;
an application search unit configured to search for applications that operate with the writing data based on the feature information to form an application candidate group; and
an application providing unit configured to display icons corresponding to applications included in the application candidate group.

11. The device of claim 10, further comprising:
an application interworking unit configured to receive a selection of an application included in the application candidate group and configured to execute the selected application to interwork with text included in the writing data.

12. The device of claim 11, further comprising a writing interface unit configured to display a result based on the writing data of an execution of the selected application.

13. The device of claim 10, wherein the application candidate group includes zero applications, and the application search unit is further configured to provide a search application as a member of the application candidate group.

14. The device of claim 10, wherein the feature information comprises a mathematical symbol and at least one application of the application candidate group comprises a calculator.

15. The device of claim 10, wherein the feature information comprises a dash and at least one application of the application candidate group comprises a phone.

16. The device of claim 10, wherein the feature information comprises a question mark and at least one application of the application candidate group comprises a search application.

17. The device of claim 10, further comprising a control unit configured to change the application candidate group as the feature information changes.

18. The device of claim 10, further comprising a writing editing unit configured to edit the written input.
